(19) United States
(12) Patent Application Publication
(10) Pub. No.: US 2018/0164227 A1
(43) Pub. Date: Jun. 14, 2018

(54) SUBSTRATE INSPECTION SYSTEM

(71) Applicant: Samsung Electronics Co., Ltd., Suwon-si (KR)

(72) Inventors: Taejoong KIM, Hwaseong-si (KR); Kwang Soo KIM, Pyeongtaek-si (KR); lwa YOICHIRO, Suwon-si (KR); Byeonghwan JEON, Yongin-si (KR); Yougduk KIM, Seongnam-si (KR); Wansung PARK, Seoul (KR); Tae-Heung AHN, Seoul (KR); Jaechol JOO, Suwon-si (KR)

(73) Assignee: Samsung Electronics Co., Ltd., Suwon-si (KR)

(21) Appl. No.: 15/800,338

(22) Filed: Nov. 1, 2017

(30) Foreign Application Priority Data
Dec. 8, 2016 (KR) 10-2016-0166904

(51) Int. Cl. G01N 21/94; G01B 11/06

(52) U.S. Cl. CPC G01N 21/94; G01B 11/06

(57) ABSTRACT

Disclosed is a substrate inspection system. The substrate inspection system comprises a substrate inspection apparatus that inspects a substrate by irradiating light thereto. The substrate inspection apparatus comprises a light source to irradiate light onto the substrate, a detector to receive light from the substrate, and a controller to control an inspection mode of the substrate inspection apparatus by controlling the light source and the detector. The inspection mode comprises a first inspection mode to inspect whether a particle is present on the substrate and a second inspection mode to inspect a thickness of the substrate.

### CROSS-REFERENCE TO RELATED APPLICATIONS

This U.S. nonprovisional patent application claims priority under 35 U.S.C § 119 of Korean Patent Application No. 10-2016-0166904 filed on Dec. 8, 2016 entire contents of which are hereby incorporated by reference.

### BACKGROUND

Inventive concepts relates to a substrate inspection system, and more particularly, to a substrate inspection system that provides an optical system to analyze the presence of particles on a substrate and an optical system to analyze a thickness of the substrate.

As semiconductor processes increase in complexity, inspecting particles on a semiconductor device increases in importance. The inspection of particles on semiconductor devices, and reduction of particles, may enhance reliability of semiconductor devices and may increase process yield. An optical apparatus may be used to inspect particles on the semiconductor device. Additional optical apparatuses may be used to inspect a thickness of a film on the semiconductor device.

### SUMMARY

Example embodiments of inventive concepts provide a substrate inspection system that decreases footprint and increases process efficiency.

In one example embodiment of inventive concepts, a substrate inspection system may comprise a substrate inspection apparatus configured to inspect a substrate by irradiating light thereto. The substrate inspection apparatus may include a light source configured to irradiate light onto the substrate; a detector configured to receive light from the substrate; and a controller configured to control the light source and the detector by operating in an inspection mode selected from a plurality of inspection modes, the plurality of inspection modes including a first inspection mode, wherein the light source and the detector are configured to inspect whether at least one particle is present on the substrate, and a second inspection mode, wherein the light source and the detector are configured to inspect a thickness of the substrate

In one example embodiment of inventive concepts, a substrate inspection system may comprise a substrate treatment apparatus configured to perform a treatment process on a substrate; a substrate transfer apparatus configured to transfer the substrate between the substrate treatment apparatus and a container in which the substrate is accommodated; a substrate inspection apparatus connected to the substrate transfer apparatus and configured to perform an inspection process on the substrate. The substrate inspection apparatus includes, a first optical system configured to obtain a scattered light from the substrate and configured to inspect whether at least one particle is present on the substrate; and a second optical system configured to obtain a spectrum of light reflected from the substrate and configured to inspect a thickness of the substrate.

In one example embodiment of inventive concepts, a substrate inspection apparatus may comprise a supporter configured to support a substrate; a first light source configured to irradiate a surface of the substrate such that light is scattered on the substrate supported by the supporter; a first detector configured to detect the scattered light; a second light source configured to irradiate a surface of the substrate such that light is reflected on the substrate supported by the supporter, and a second detector configured to detect the reflected light

Details of other example embodiments are included in the description and drawings.

### BRIEF DESCRIPTION OF THE DRAWINGS

FIG. 1 roughly shows a substrate inspection system according to example embodiments of inventive concepts.

FIG. 2 is a cross-sectional view taken along line II-II′ of FIG. 1.

FIG. 3 shows an optical system of FIG. 2.

FIG. 4 shows substrate inspection apparatus operating in a first inspection mode.

FIG. 5 shows a substrate inspection apparatus operating in a spot inspection mode chosen from a second inspection mode.

FIG. 6 shows a substrate inspection apparatus operating in a line inspection mode chosen from a second inspection mode.

FIG. 7 shows substrate inspection apparatus operating in an area inspection mode chosen from a second inspection mode.

FIG. 8 shows how reflectance depends on wavelength at various incident angles of light of a second optical system.

### DETAILED DESCRIPTION

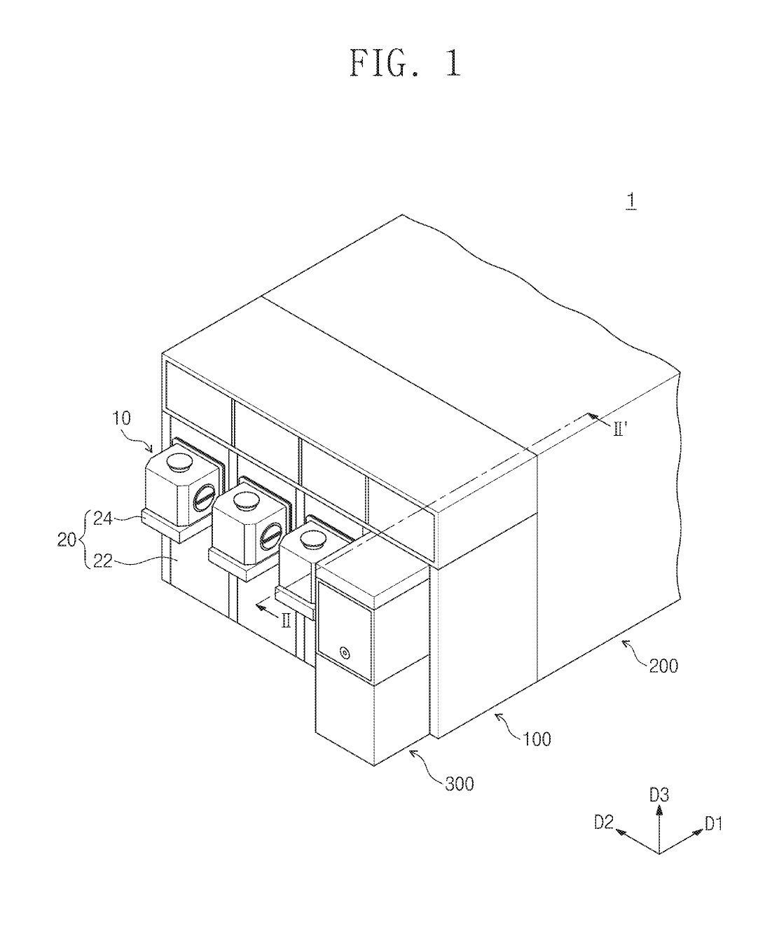

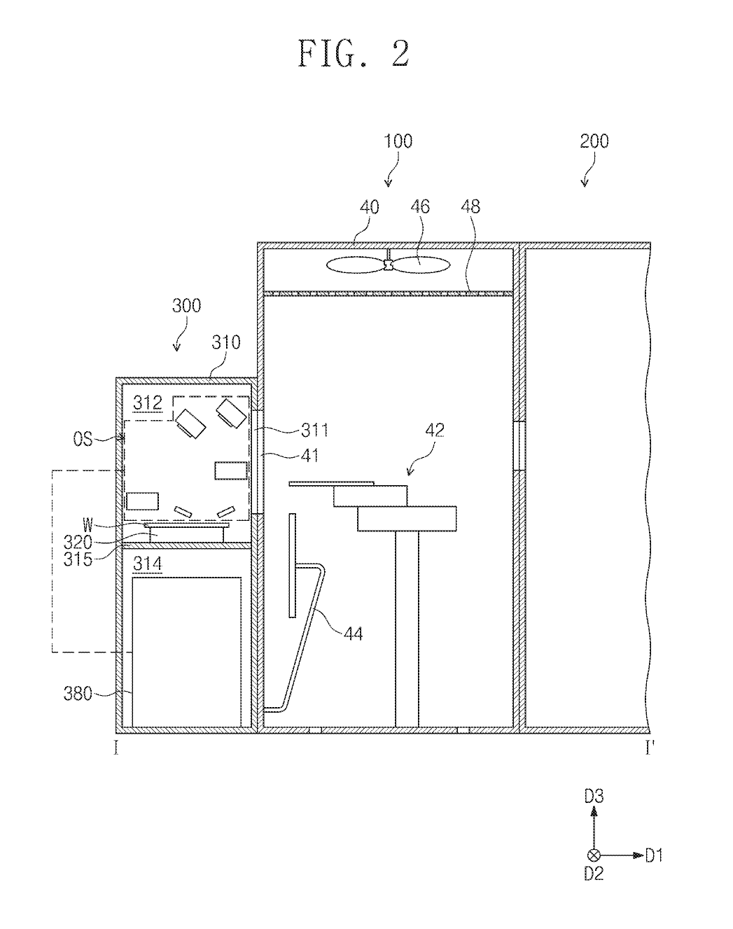

FIG. 1 shows a substrate inspection system 1 according to example embodiments of inventive concepts. FIG. 2 is a cross-sectional view taken along line II-II′ of FIG. 1. The substrate inspection system 1 may include a substrate transfer apparatus 100, a substrate treatment apparatus 200, and a substrate inspection apparatus 300. The substrate transfer apparatus 100 and the substrate treatment apparatus 200 may be arranged along a first direction D1. A second direction D2 may be defined perpendicular to the first direction D1, and a third direction D3 may be defined perpendicular to the first and second directions D1 and D2.

Referring to FIGS. 1 and 2, the substrate transfer apparatus 100 may transfer a substrate W between a container 10 and the substrate treatment apparatus 200. The substrate W may be but is not limited to be a semiconductor wafer. The substrate transfer apparatus 100 may include a load port 20 and a first housing 40. The load port 20 may have a vertical frame 22 and a support member 24. The vertical frame 22 may be inserted into an opening 41 at a front surface of the first housing 40, so that the first housing 40 may be hermetically sealed. The support member 24 may protrude from the vertical frame 22 to provide a space where the container 10 is placed. FIG. 1 illustrates three load ports 20 arranged along the second direction D2, but the number and arrangement of the load port 20 are not limited thereto.

The first housing 40 may be coupled with a front side of the substrate treatment apparatus 200. The first housing 40 may include a first opening 41, a transfer robot 42, a door opener 44, a fan 46, and a filter 48. The transfer robot 42 may transfer the substrate W between the container 10 and the substrate treatment apparatus 200. The transfer robot 42 may rotate and/or move based on a Cartesian coordinate system and/or a polar coordinate system. The transfer robot 42 may take in/out the substrate W in the container 10 and bring and/or take the substrate W into and/or from the substrate treatment apparatus 200. Likewise, the transfer robot 42 may transfer the substrate W between the substrate inspection apparatus 300, the container 10, and the substrate treatment apparatus 200.

The door opener 44 may open and close a door (not shown) of the container 10. Although shown in figures, the container 10 may receive therein a plurality of the substrates W. The container 10 may protect the substrate W from foreign objects or chemical contamination in the air during transportation of the substrate W. For example, the container 10 may be a FOUP (Front Open Unified Pod); however, inventive concepts are not limited thereto. The fan 46 and the filter 48 may be installed on an upper portion of the first housing 40. The fan 46 may allow air to flow from the upper portion of the first housing 40 into a lower portion of the first housing 40, and the filter 48 may remove particles from the air.

The substrate treatment apparatus 200 may perform at least one treatment process on the substrate W. For example, the treatment process may be or may include an etching process, a deposition process, a polishing process, and/or other processes, but inventive concepts are not limited thereto and various semiconductor processes may be performed.

The substrate inspection apparatus 300 may perform an inspection process on the substrate W. For example, the substrate inspection apparatus 300 may perform an optical inspection process on the substrate W. The substrate inspection apparatus 300 may include a second housing 310, a supporter 320, an optical system OS, and a controller 380.

The second housing 310 may provide internal spaces 312 and 314 where the inspection process is performed. The second housing 310 may include a partition wall 315, which provides the second housing 310 with a first space 312 and a second space 314 separated from each other. FIG. 2 illustrates that the supporter 320 and the optical system OS are in the first space 312 corresponding to an upper portion of the second housing 310 and the controller 314 is in the second space 314 corresponding to a lower portion of the second housing 310, but shape, structure, and component arrangement of the second housing 310 are not limited thereto. The second housing 310 may have a side at which a second opening 311 is formed to face the first opening 41. The second opening 311 may be capable of being opened and closed.

The second housing 310 may be coupled to the substrate transfer apparatus 100. For example, as shown in FIG. 1, the second housing 310 may be associated with a front surface of the substrate transfer apparatus 100. The substrate inspection apparatus 300, the substrate transfer apparatus 100, and the substrate treatment apparatus 200 may be sequentially arranged along the first direction D1. The second housing 310 may have the same width as that of the load port 20. The second housing 310 may thus be coupled with the substrate transfer apparatus 100 instead of the load port 20. However, inventive concepts are not limited thereto. For example, the second housing 310 may be associated with a side surface of the substrate transfer apparatus 100. Furthermore, the second housing 310 may be provided as a stand-alone facility without being associated with other facilities.

The substrate W may be placed on the supporter 320. The support 320 may move and/or rotate the substrate W. For example, the supporter 320 may move the substrate W based on a polar coordinate system, but inventive concepts are not limited thereto and the substrate W may travel in a Cartesian coordinate system. Although not shown in figures, the supporter 320 may include an aligner to align the substrate W.

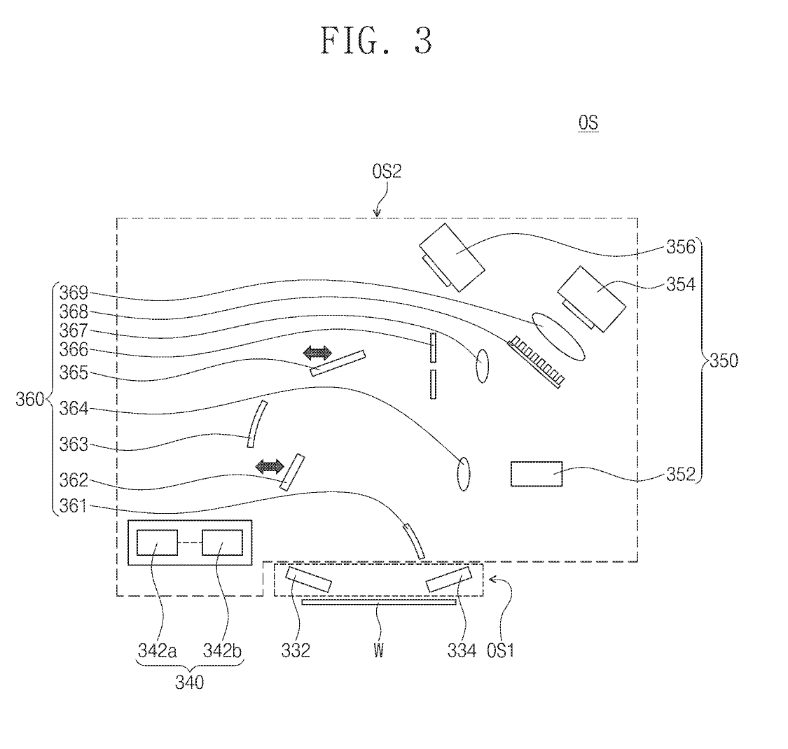

FIG. 3 shows the optical system OS of FIG. 2. FIG. 3 illustrates configuration and arrangement of an optical system, but inventive concepts are not limited thereto. FIG. 3 partly shows exaggerations and omissions for clarity of the description, but actual size and ratio of components may be different from those depicted. For clarity of the description, an illuminating light is named to refer to light from a light source to be incident onto the substrate W, a scattered light is named to refer to light scattered from the substrate W, and a reflective light is named to refer to light reflected from the substrate W. The optical system OS may include a first optical system OS1 and a second optical system OS2. The first optical system OS1 may acquire the scattered light from the substrate W to analyze the presence of particles on the substrate W, and the second optical system OS2 may acquire the reflective light from the substrate W to analyze a thickness of the substrate W. The thickness of the substrate W may be a whole thickness of the substrate W or a thickness of specific layer(s) or film(s) on the substrate W. For example, the first optical system OS1 may be or may include a dark field optical system, and the second optical system OS2 may be or may include a spectral reflectometry optical system. The layer(s) or film(s) may be transparent, but inventive concepts are not limited thereto.

The first optical system OS1 may include a first light source 332 and a first detector 334. The first light source 332 may be or may include, for example, a laser diode. The first light source 332 may irradiate the illuminating light onto the substrate W. The illuminating light may be but is not limited to be light from the visible spectrum. The first detector 334 may collect the scattered light from the substrate W onto which the first light source 332 irradiates the illuminating light. The controller 380 may receive information about the scattered light from the first detector 334, and the information may be used for the controller 380 to determine whether particles are present on the substrate W.

The second optical system OS2 may include a second light source 340, a second detector 350, and optical elements 360. The second light source 340 may have a broadband light source 342a and a monochromatic member 342b. The broadband light source 342a may irradiate broadband light, and the monochromatic member 342b may selectively take a specific wavelength light from the broadband light. The monochromatic member 342b may be or may include, for example, a monochromator. The controller 380 may control operation of the monochromatic member 342b in accordance with an inspection mode discussed below.

The second detector 350 may include a spectrometer 352, a first camera 354, and a second camera 356. The second detector 350 may obtain information about various shapes on the substrate, the shapes including a spot, a line, and an area. The spectrometer 352 may obtain information about a spot on the substrate W, the first camera 354 may obtain information about a line on the substrate W, and the second camera 356 may obtain information about an area on the substrate W. These will be discussed below. The spot, the line, and the area may have their relative sizes; the line may have a size greater than that of the spot and less than that of the area.

The optical elements 360 may include curved mirrors 361 and 363 (e.g., spherical or parabolic mirrors), folding mirrors 362 and 365, lenses 364, 367, and 369, a slit 366, and a grating 368. The folding mirrors 362 and 365 may be configured to move. The controller 380 may control the movement of the folding mirrors 362 and 365.

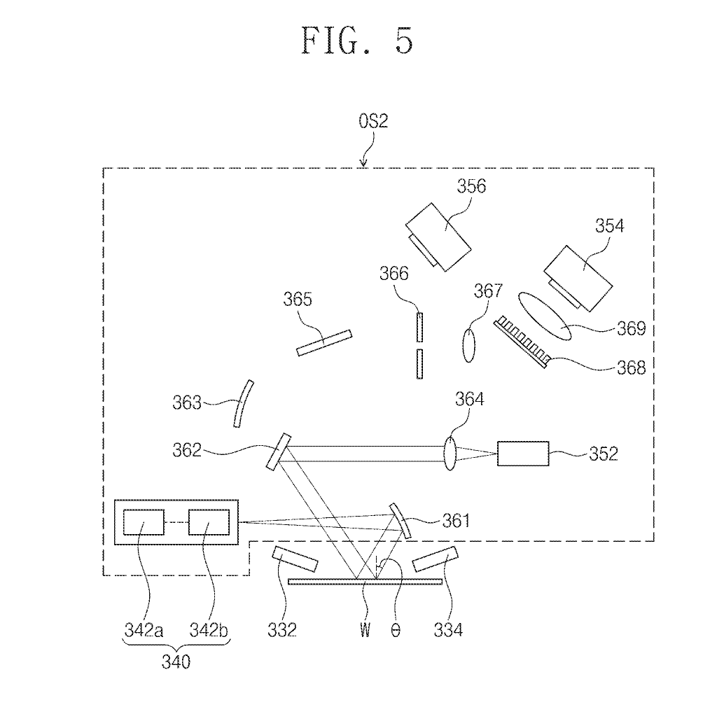

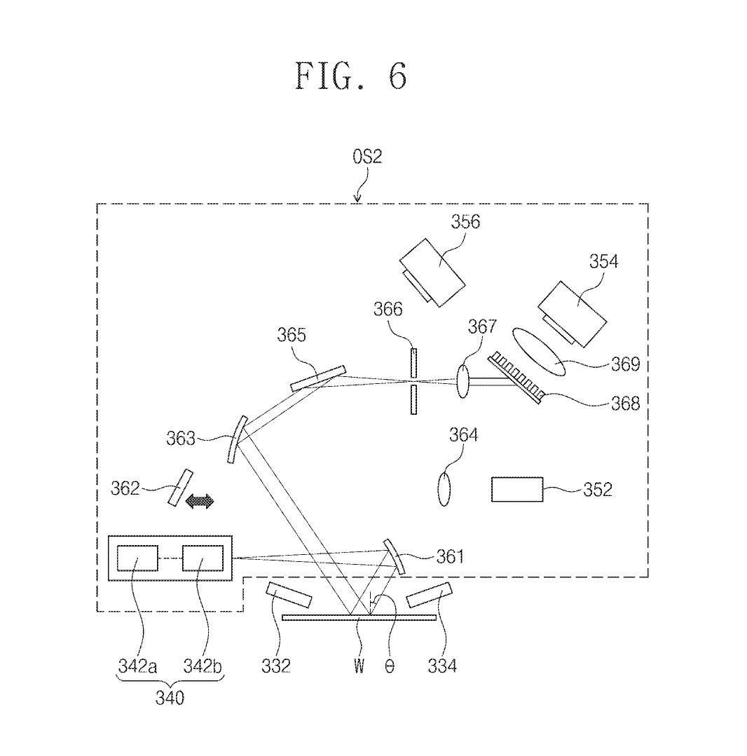

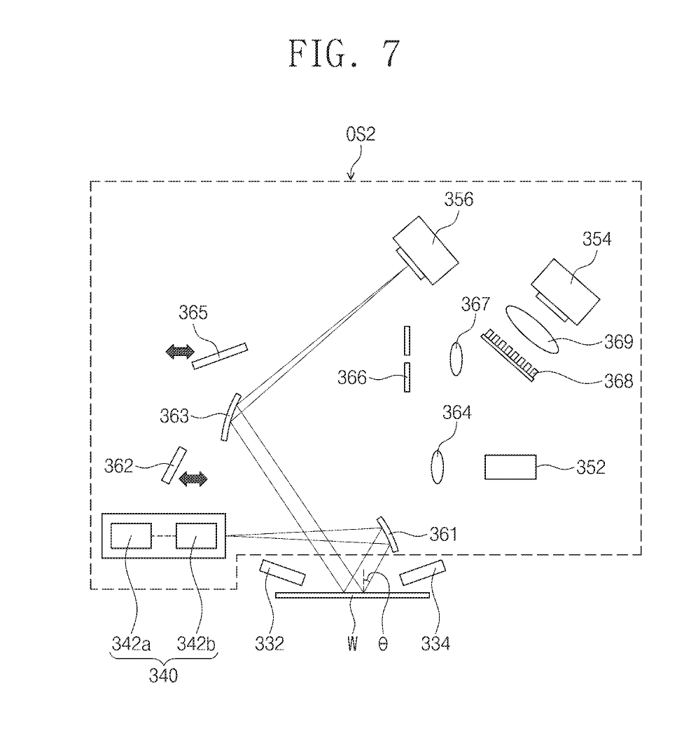

Inspection processes for the spot, the line, and the area may be performed with different combinations of the optical elements 360. In this description, a first optical set may be defined to include a combination of the optical elements 361, 362, and 364 that are used when the second optical system OS2 inspects a thickness of the spot under a spot inspection mode (see FIG. 5), a second optical set may be defined to include a combination of the optical elements 361, 363, 365, 366, 367, 368, and 369 that are used when the second optical system OS2 inspects a thickness of the line under a line inspection mode (see FIG. 6), and a third optical set may be defined to include a combination of the optical elements 361 and 363 that are used when the second optical system OS2 inspects a thickness of the area under an area inspection mode (see FIG. 7). A kind, size, and arrangement of the optical elements 360 shown herein are just illustrative examples and inventive concepts are not limited thereto. The spot inspection mode, the line inspection mode, and the area inspection mode may be modes of the second inspection mode.

Referring to FIG. 2, the controller 380 may control the optical system OS. The controller 380 may selectively control the first optical system OS1 and the second optical system OS2. The controller 380 may control the light sources 332 and 340, the detectors 334 and 350, and the optical elements 360. The controller 380 may control an inspection mode of the substrate inspection apparatus 300. The inspection mode may include a first inspection mode and a second inspection mode, and all of the spot, line, and area inspection modes may be included in the second inspection mode. The controller 380 may include a software part (not shown) and a display part (not shown).

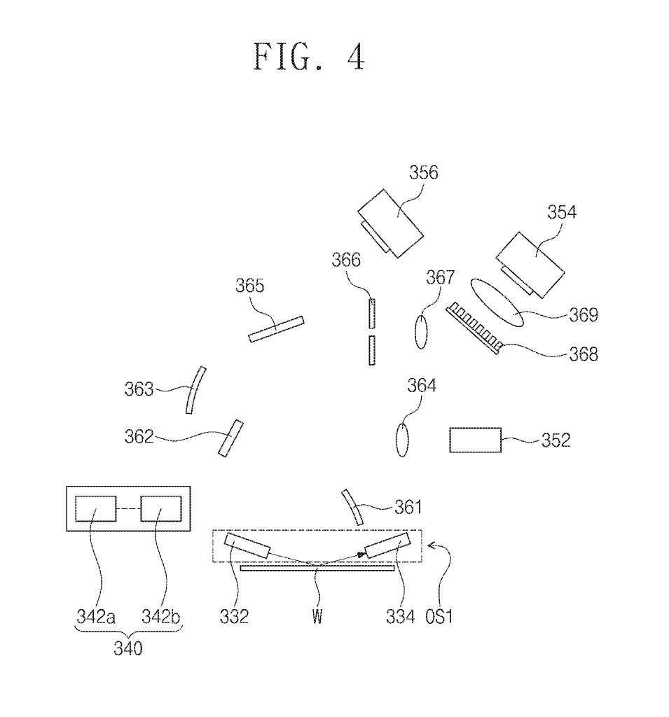

FIG. 4 shows the first inspection mode of the substrate inspection apparatus 300, and FIGS. 5 to 7 show the second inspection mode of the substrate inspection apparatus 300. In more detail, FIG. 5 shows the spot inspection mode of the substrate inspection apparatus 300, FIG. 6 shows the line inspection mode of the substrate inspection apparatus 300, and FIG. 7 shows the area inspection mode of the substrate inspection apparatus 300.

Referring to FIGS. 3 and 4, under the first inspection mode, the controller 380 may control the first optical system OS1 to perform the first inspection mode. The controller 380 may control such that the first light source 332 irradiates the illuminating light onto the substrate W and the first detector 334 collects the scattered light from the substrate W. The first detector 334 may transfer information about the scattered light to the controller 380, and then the controller 380 may inspect whether particles are present or not on the substrate W.

Referring to FIGS. 3 and 5, under the spot inspection mode of the second inspection mode, the controller 380 may control the second optical system OS2 to perform the spot inspection mode. Under the spot inspection ode, the controller 380 may control the broadband light source 342a, the spectrometer 352, and the first optical set 361, 362, and 364 such that the broadband light source 342a irradiates the illuminating light onto the substrate W and the spectrometer 352 collects the reflected light. The spectrometer 352 may transfer information about a reflected spectrum to the controller 380, and then the information may be used for the controller 380 to inspect a thickness of the substrate W. Under the spot inspection mode, the controller 380 may inspect a thickness of the spot on the substrate W. The spot may have a size, for example, of about 20 um×20 um. The first optical set 361, 362, and 364 may allow the spectrometer 352 to receive light irradiated from the broadband light source 342a. As discussed above, the first optical set 361, 362, and 364 may include the curved mirror 361, the folding mirror 362, and the lens 364, but inventive concepts are not limited thereto.

Referring to FIGS. 3 and 6, under the line inspection mode of the second inspection mode, the controller 380 may control the second optical system OS2 to perform the line inspection mode. Under the line inspection mode, the controller 380 may control the broadband light source 342a, the first camera 354, and the second optical set 361, 363, 365, 366, 367, 368, and 369 such that the broadband light source 342a irradiates the illuminating light onto the substrate W and the first camera 354 collects the reflected light. The first camera 354 may transfer data about a reflected spectrum to the controller 380, and then the data may be used for the controller 380 to inspect a thickness of the substrate W. Under the line inspection mode, the controller 380 may inspect a thickness of the line on the substrate W. The line may have a size, for example, of about 20 um×1 mm. For example, the line may correspond to a pattern on the substrate W. The second optical set 361, 363, 365, 366, 367, 368, and 369 may allow the first camera 354 to receive light irradiated from the broadband light source 342a. For example, the second optical set 361, 363, 365, 366, 367, 368, and 369 may include the cured mirrors 361 and 363, the folding mirror 365, the slit 366, the grating 368, and the lenses 367 and 369, but inventive concepts is are not limited thereto. Light passing through the grating 368 may be separated by wavelength, and the first camera 354 may obtain data about the line at various wavelengths.

Referring to FIGS. 3 and 7, under the area inspection mode of the second inspection mode, the controller 380 may control the second optical system OS2 to perform the area inspection mode. Under the area inspection mode, the controller 380 may control the broadband light source 342a, the monochromatic member 342b, the second camera 356, and the third optical set 361 and 363 such that the substrate W is irradiated with the illuminating monochrome light that is monochromated by the monochromatic member 342b after being emitted from the broadband light source 342a. The second camera 356 collects the reflected light. The second camera 356 may transfer data about a reflected spectrum to the controller 380, and then the data may be used for the controller 380 to inspect a thickness of the substrate W. Under the area inspection mode, the controller 380 may inspect a thickness of the area on the substrate W. The area may have a size, for example, of about 1 mm×1 mm. The third optical set 361 and 363 may allow the second camera 356 to receive light irradiated from the monochromatic member 342b. For example, the third optical set 361 and 363 may include the curved mirrors 361 and 363, but inventive concepts are not limited thereto.

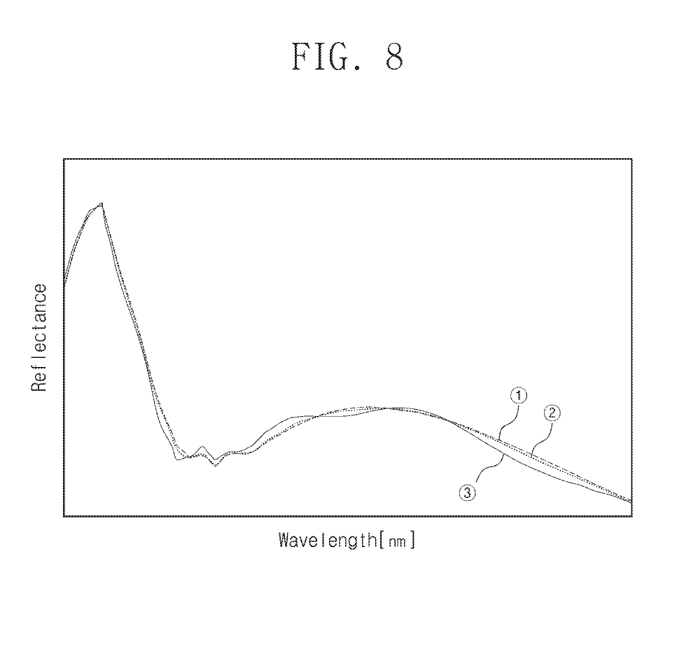

FIG. 8 shows how reflectance depends on wavelength at various incident angles θ of light of the second optical system OS2. In FIG. 8, symbol \textcircled{1} (the number one enclosed in a circle) denotes a case that the incident angle θ is 0° (i.e., light is vertically incident onto the substrate W), symbol \textcircled{2} (the number two enclosed in a circle) denotes a case that the incident angle θ is about 5°, and symbol \textcircled{3} (the number three enclosed in a circle) denotes a case that the incident angle θ is about 10°.

Referring to FIGS. 5 to 7, the controller 380 may control in the second optical system OS2 in such a way that the substrate W is irradiated with light at the incident angle θ falling within a specific range. For example, the controller 380 may control the incident angle θ to fall within a range of about 5°. Referring to symbols \textcircled{1} and \textcircled{2} of FIG. 8 (the numbers one and two enclosed in a circle), the case that the incident angle θ is about 5° may have almost same reflectance-versus-wavelength as that in the case that light is vertically incident onto the substrate W. In contrast, referring to symbol L (the number three enclosed in a circle) the case that that the incident angle θ is about 10° may have an increased error in reflectance-versus-wavelength.

In general, a spectral reflectometry optical system vertically irradiates light onto a substrate. A beam splitter may be needed or desired in order to vertically irradiate light onto the substrate. For example, a first splitter may be needed or desired to guide light from a light source into the substrate, and a second splitter may be needed or desired to guide a reflective light from the substrate into a detector. In this case, only about 25% of the incident light may be received and thus light loss may occur. However, according to inventive concepts, reflective mirrors may be used to achieve spectral reflectometry and to decrease light loss even in the case that the substrate is irradiated with light at the incident angle θ of about 5° or less.

According to inventive concepts, a substrate inspection system may provide a single substrate inspection apparatus with a first optical system to inspect the presence of particles on the substrate and a second optical system to inspect a thickness of the substrate. As other substrate inspection apparatuses for separately inspecting the substrate are not required, a footprint may be reduced and process efficiency may be increased.

The substrate inspection apparatus may be provided to have the same width as that of a load port, and thereby compatibility may increase when the substrate inspection apparatus is detached from and attached to a substrate transfer apparatus. Alternatively, the substrate inspection apparatus may be provided as a stand-alone facility without being associated with other facilities. In addition, as the substrate inspection apparatus includes diverse optical inspection modes, it may be possible to selectively perform an inspection process suitable for a kind and step of each of processes.

In the aforementioned description, the optical system OS and the controller 380 are provided in the second housing 310 having the same width as that of the load port 20, but inventive concepts are not limited to this example embodiment.

The effects of inventive concepts are not limited to the aforementioned effects. Other effects, which are not mentioned above, will be apparently understood by one skilled in the art from the foregoing description and accompanying drawings.

These example embodiments herein are presented to facilitate understanding of inventive concepts and should not limit the scope of inventive concepts, and the disclosed is intended that inventive concepts cover various combinations, modifications, and variations. The technical protection scope of inventive concepts will be defined by the technical spirit of the appended claims, and is intended to include all modifications and equivalent substantially falling within the spirit and scope of the invention while not being limited by literary descriptions in the appended claims.

What is claimed is:

1. A substrate inspection system,comprising:
a substrate inspection apparatus configured to inspect a substrate by irradiating light thereto,
the substrate inspection apparatus including,
a light source configured to irradiate light onto the substrate;
a detector configured to receive light from the substrate; and
a controller configured to control the light source and the detector by operating in an inspection mode selected from a plurality of inspection modes, the plurality of inspection modes including a first inspection mode and a second inspection mode, in the first inspection mode the light source and the detector are configured to inspect whether at least one particle is present on the substrate, and in the second inspection mode the light source and the detector are configured to inspect a thickness of the substrate.

2. The substrate inspection system of claim 1, wherein
the light source includes first and second light sources; and
the detector includes first and second detectors, and
the controller is configured to operate in the first mode to control the first light source and the first detector, and the controller is configured to operate in the second mode to control the second light source and the second detector.

3. The substrate inspection system of claim 2, wherein
the second light source includes a broadband light source;
the second detector includes a spectrometer; and
the substrate inspection system further includes a first optical set configured to guide light from the broadband light source into the spectrometer.

4. The substrate inspection system of claim 3, wherein
the substrate inspection apparatus is configured to operate in a spot inspection mode of the second inspection mode wherein the second light source and the second detector are configured to inspect a thickness of a spot on the substrate; and
the controller is configured to control the broadband light source, the first optical set, and the spectrometer to inspect the thickness of the spot in the spot inspection mode.

5. The substrate inspection system of claim 2, wherein
the second light source includes a broadband light source;
the second detector includes a first camera; and
the substrate inspection system further includes a second optical set configured to guide light from the broadband light source into the first camera.

6. The substrate inspection system of claim 5, wherein
the substrate inspection apparatus is configured to operate in a line inspection mode of the second inspection mode wherein the second light source and the second detector are configured to inspect a thickness of a line on the substrate; and
the controller is configured to control the broadband light source, the second optical set, and the first camera to inspect the thickness of the line under the line inspection mode.

7. The substrate inspection system of claim 2, wherein
the second light source includes a broadband light source and a monochromatic member, the monochromatic member configured to take monochrome light from the broadband light source;
the second detector includes a second camera; and
the substrate inspection system further comprises a third optical set configured to guide light from the monochromatic member to the second camera.

8. The substrate inspection system of claim 7 wherein
the substrate inspection apparatus is configured to operate in an area inspection mode of the second inspection mode, wherein the second light source and the second detector are configured to inspect a thickness of an area on the substrate; and
the controller is configured to control the broadband light source, the monochromatic member, the third optical set, and the second camera to inspect the thickness of the area under the area inspection mode.

9. The substrate inspection system of claim 2, wherein
the controller is configured to control the second light source and the second detector in the second inspection mode such that the second light source irradiates the substrate with light at an incident angle falling within a range of about 5°.

10. The substrate inspection system of claim 2, wherein
the substrate inspection apparatus is configured to operate in the first inspection mode such that the controller collects a scattered light from the substrate to inspect whether the at least one particle is present; and
the substrate inspection apparatus is configured to operate in the second inspection mode such that the controller collects a reflective light from the substrate to inspect the thickness.

11. The substrate inspection system of claim 1, further comprising:
a substrate treatment apparatus configured to perform at least one treatment process on the substrate;
a substrate transfer apparatus configured to transfer the substrate between the substrate treatment apparatus and a container in which the substrate is accommodated, and wherein
wherein the substrate inspection apparatus is connected to the substrate transfer apparatus.

12. The substrate inspection system of claim 11, wherein
the substrate transfer apparatus includes a load port on which the container is placed; and
the substrate inspection apparatus has a same width as a width of the load port.

13. A substrate inspection system, comprising:
a substrate treatment apparatus configured to perform at least one treatment process on a substrate;
a substrate transfer apparatus configured to transfer the substrate between the substrate treatment apparatus and a container in which the substrate is accommodated;
a substrate inspection apparatus connected to the substrate transfer apparatus and configured to perform an inspection process on the substrate, and wherein
the substrate inspection apparatus includes,
a first optical system configured to obtain a scattered light from the substrate and configured to inspect whether at least one particle is present on the substrate, and
a second optical system configured to obtain a spectrum of light reflected from the substrate and configured to inspect a thickness of the substrate.

14. The substrate inspection system of claim 13, further comprising
a controller configured to control inspection mode of the substrate inspection apparatus by selectively controlling the first optical system and the second optical system; wherein
the inspection mode includes,
a spot inspection mode wherein the substrate inspection apparatus is configured to inspect a thickness of a spot on the substrate,
a line inspection mode wherein the substrate inspection apparatus is configured to inspect a thickness of a line on the substrate, and
an area inspection mode wherein the substrate inspection apparatus is configured to inspect a thickness of an area on the substrate, a size of the spot is smaller than a size of the fine, and the size of the line smaller than a size of the area; and
the controller is configured to control the second optical system based on one of the spot, line, and area inspection modes.

15. The substrate inspection system of claim 13, wherein
the substrate transfer apparatus includes a load port on which the container is placed; and
the substrate inspection apparatus has a same width as a width of the load port.

16. The substrate inspection system of claim 14, wherein the substrate inspection apparatus includes,
at least one folding mirror, wherein
the controller is configured to control the at least one folding mirror to be in a first position in response to the inspection mode being the spot inspection mode, and the controller is configured to control the at least one folding mirror to be in a second position in response to the inspection mode being the line inspection mode.

17. A substrate inspection apparatus comprising:
a supporter configured to support a substrate;
a first light source configured to irradiate a surface of the substrate such that light is scattered on the substrate supported by the supporter;
a first detector configured to detect the scattered light;
a second light source configured to irradiate a surface of the substrate such that light is reflected from the substrate supported by supporter; and
a second detector configured to detect the reflected light.

18. The substrate inspection apparatus of claim 17, wherein the second detector is configured to detect the reflected light from a shape on the substrate, the shape selected from a group including,
a spot of about 20 um×20 um in size,
a line of about 20 um×1 mm in size,
and an area of about 1 mm×1 mm in size.

19. A substrate inspection system comprising:
the substrate inspection apparatus of claim 17; and
a substrate treatment apparatus connected to the substrate inspection apparatus and configured to perform at least one treatment process on the substrate based on output from the substrate inspection apparatus.

20. The substrate inspection system of claim 19, wherein
the substrate treatment apparatus is configured to perform at least one of an etching process, a deposition process, and a polishing process on the substrate.
